(19) United States
(12) Patent Application Publication
(10) Pub. No.: US 2015/0251279 A1
(43) Pub. Date: Sep. 10, 2015

(54) Tank welding fixture and method

(71) Applicant: Robert Wruck, Kirkland, IL (US)

(72) Inventor: Robert Wruck, Kirkland, IL (US)

(21) Appl. No.: 14/638,597

(22) Filed: Mar. 4, 2015

Related U.S. Application Data
(60) Provisional application No. 61/947,685, filed on Mar. 4, 2014.

(51) Int. Cl. B23K 37/04; B23K 37/053; B23K 9/007

(52) U.S. Cl. CPC B23K 37/0452; B23K 9/007; B23K 37/053

(57) ABSTRACT

A cylindrical tank welding fixture and related process allows a tank to be attached to a robotic welder. Each of the two endcap sections of the fixture shall be clamped around an endcap of the tank, prior to tacking the tank body around each endcap utilizing a tacking stand, in preparation for robotic welding. Each of the endcap sections of the fixture utilizes four jaws, applying clamping force from four points, each directly across from another. The jaws clamp and secure the dished endcaps of the tank in position while incorporating gauges which slide inward in a T-slot, enabling them to be easily removed by sliding them away from the endcap after tacking is completed. Removal of the gauges enables the user to robotically weld the main seams of the tank without the gauges interfering with the robot torch neck. After the tank is tacked and ready to weld, the tank is hoisted into the robot and attached, using pins which will orient and position the tank consistently. The robot is similar to a lathe, having a drive side and a tail stock side which spins freely.

### CROSS-REFERENCE TO RELATED APPLICATIONS

This application claims the benefit of U.S. Provisional Application No. 61/947,685, filed Mar. 4, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to welding equipment and accessories, and in particular to a cylindrical tank welding fixture and related process. Many welding and machining shops manufacture and repair cylindrical tanks as part of their everyday production, and rotating the heavy, cumbersome cylindrical structures while robotically tacking the body and seams is a difficult task. The motion of the tank must be uniform to create quality tacks. A cylindrical tank welding fixture and related process, which secures each endcap of the tank in a pair of jaws and rotates the tank at the same speed the robot tacks and welds, would resolve these problems.

### SUMMARY OF THE INVENTION

Accordingly, the invention is directed to a cylindrical tank welding fixture and related process allows a tank to be attached to a robotic welder. Each of the two endcap sections of the fixture shall be clamped around an endcap of the tank, prior to tacking the tank body around each endcap utilizing a tacking stand, in preparation for robotic welding. Each of the endcap sections of the fixture utilizes four jaws, applying clamping force from four points, each directly across from another. The jaws clamp and secure the dished endcaps of the tank in position while incorporating gauges which slide inward in a T-slot, enabling them to be easily removed by sliding them away from the endcap after tacking is completed. Removal of the gauges enables the user to robotically weld the main seams of the tank without the gauges interfering with the robot torch neck. After the tank is tacked and ready to weld, the tank is hoisted into the robot and attached, using pins which will orient and position the tank consistently. The robot is similar to a lathe, having a drive side and a tail stock side which spins freely. This allows the tank to rotate as the robot welds simultaneously.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front perspective view of the first exemplary embodiment, displaying the robot 10, the sliding door 10A, the pin 11, the endcap sections 12, and the tank 13.

FIG. 2 is a front view of the first exemplary embodiment, displaying the robot 10, the sliding door 10A, the pin 11, the endcap sections 12, and the tank 13.

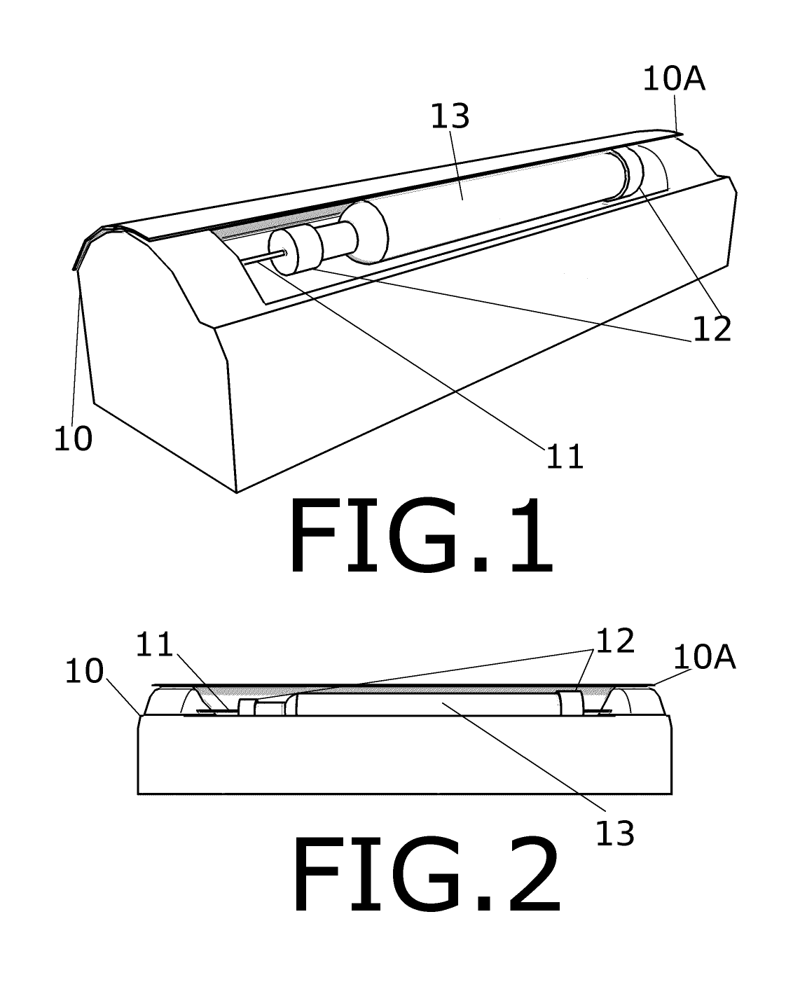

### DETAILED DESCRIPTION OF THE INVENTION

Referring now to the invention in more detail, the invention is directed to a tank welding fixture and related process. The fixture comprises multiple endcap sections 12 and is designed to attach to the endcaps on each side of a tank, prior to tacking the body and seams of the tank. The two endcap sections 12 of the fixture each utilize four jaws which clamp and secure the dished endcaps of the tank in position while incorporating gauges which slide inward in a T-slot, enabling them to be easily removed by sliding them away from the endcap after tacking is completed. Removal of the gauges enables the user to robotically weld the main seams of the tank without the gauges interfering with the robot torch neck. After the tank is tacked and ready to weld, the tank is hoisted into the robot 10 and attached, using collinear pins 11 which will orient and position the tank consistently. The robot 10 is similar to a lathe, having a drive side (rotation of the pin 11 is mechanically driven by any type of motor) and a tail stock side which spins freely. This allows the tank to rotate as the robot 10 welds simultaneously.

The first exemplary embodiment provides a pair of endcap sections 12, which are secured to the endcaps of a tank, which is preferably cylindrical, prior to tacking and welding. The endcap sections 12 are temporarily mounted on a tacking stand, and each is secured to an endcap of the tank with four jaws, which clamp down and secure the endcap. When tacking is completed, the tank is hoisted from the tacking stand, with the endcap sections 12 still affixed to the endcaps, and lowered into the robot positioner for robotic welding.

The drive side and tail stock side of the robot 10 each provide a saddle, within which the pin 11 on each endcap section 12 is secured. The pins 11 and the saddles operate on the same principle as a lathe, rotating the tank and endcap sections 12 in rotisserie fashion, but with a detachable chuck which drops into position. A sliding door 10A may be closed over the tank and endcap sections 12 during welding.

The related manufacturing process requires the use of two sets of endcap sections 12. This enables the tack and robotic welding operations to be conducted simultaneously. One worker may use the tacking stand to tack a tank together, while a second worker operates the robot 10 to weld a tank which was previously tacked, which minimizes down time. Changeovers for different tank sizes are substantially reduced or eliminated. To accommodate tanks of various lengths, the tail stock side of the robot 10 must be adjusted lengthwise by pulling a pin and sliding the end to the desired location along a rail, then securing it with the pin. The jaws of the endcap sections 12 slide in a T-slot to accommodate tanks of various diameters. Various style reservoirs and brackets are contemplated with use of the process described herein.

The robot 10, the sliding door 10A, the pins 11, and the endcap sections 12 are preferably manufactured from rigid, durable materials, such as steel or aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A tank welding fixture comprising:
(a) a pair of pins;
(b) said pair of pins being collinear;
(c) each of said pair of pins terminating in an endcap;
(d) each of said pair of pins being releasably engageable to one of a pair of saddles;
(e) said endcap being configured for releasably engaging to a tank;
(f) one of said pair of saddles being rotationally driven, and one of said pair of saddles allowing free rotation; and
(g) said pair of saddles being configured for positioning said pair of pins relative to a welding robot.

2. A method of operating a tank welding fixture, the fixture comprising:
(a) a pair of pins;
(b) said pair of pins being collinear;
(c) each of said pair of pins terminating in an endcap;
(d) each of said pair of pins being releasably engageable to one of a pair of saddles;
(e) said endcap being configured for releasably engaging to a tank;
(f) one of said pair of saddles being rotationally driven, and one of said pair of saddles allowing free rotation; and
(g) said pair of saddles being configured for positioning said pair of pins relative to a welding robot;
and the method comprising:
(g) tacking said tank;
(h) affixing said pair of pins to said tank, one at each end thereof, using said endcap;
(i) hoisting said tank together with said pair of pins into said pair of saddles; and
(j) using said saddles to position said tank in conjunction with using said welding robot to weld said tank.
